(19) United States
(12) Patent Application Publication
(10) Pub. No.: US 2025/0088783 A1
(43) Pub. Date: Mar. 13, 2025

(54) EARPHONES

(71) Applicant: SHENZHEN SHOKZ CO., LTD., Shenzhen (CN)

(72) Inventors: Yujia HUANG, Shenzhen (CN); Wenjun DENG, Shenzhen (CN); Yongshuai YUAN, Shenzhen (CN); Wenbing ZHOU, Shenzhen (CN); Fengyun LIAO, Shenzhen (CN); Xin QI, Shenzhen (CN)

(73) Assignee: SHENZHEN SHOKZ CO., LTD., Shenzhen (CN)

(21) Appl. No.: 18/956,249

(22) Filed: Nov. 22, 2024

Related U.S. Application Data
(63) Continuation of application No. PCT/CN2023/072360, filed on Jan. 16, 2023.

(51) Int. Cl. H04R 1/10

(52) U.S. Cl. CPC H04R 1/1016

(57) ABSTRACT

Disclosed is an earphone comprising two speaker assemblies and a connection member. The connection member is used to connect the two speaker assemblies. The connection member provides a clamping force for placing the two speaker assemblies at a user's head through a bending deformation. The connection member includes a housing with an accommodation cavity, a capacitance sensor is disposed in the accommodation cavity, and the capacitance sensor is configured to identify a bending state of the connection member. The capacitance sensor includes a shielding structure that has a constant potential and is used to reduce an effect of an external electric field on the capacitance sensor.

### CROSS-REFERENCE TO RELATED APPLICATIONS

This application is a continuation of Interactional Patent Application No. PCT/CN2023/072360, filed on Jan. 16, 2023, the contents of which are hereby incorporated by reference.

### TECHNICAL FIELD

The present disclosure relates to the field of acoustic technology, and in particular to an earphone.

### BACKGROUND

In the current earphone market, sensors are widely used for wearing detection of products such as earphones. By using the sensors, a user's movement of wearing or removing the earphone can be identified, and accordingly, an operating state of the earphone can be adjusted, which greatly improves a use experience.

Currently, the sensors used for wearing detection are mainly contact sensors. However, factors such as perspiration and mis-touching may cause the contact sensors to have a poor accuracy in the wear detection of the earphone. The wearing detection according to different deformations of a connection structure of an earphone in different wearing states of the earphone, i.e., using a bending sensor to identify the wearing detection of the earphone, has relatively high accuracy. Among the bending sensors, capacitance sensors are widely used for wearing detection due to their advantages of low hysteresis, high linearity, and high sensitivity. However, in a situation of relying on the slight deformation caused by wearing to change the capacitance value, due to the limitation of specificity of the structure, an absolute value of capacitance of the capacitance sensor itself as well as the detection value caused by the slight deformation are very small. According to the detection principle of the capacitance sensor, the detection result is easily affected by external electric field changes, resulting in the detection value being easily confused with an external error, thus reducing the accuracy of the detection of the capacitance sensor. For example, when a human body approaches the capacitance sensor as a conductor, it can cause changes in the electric field distribution, resulting in an inaccurate detection result. Therefore, there is a need for an electromagnetic shielding design for the capacitance sensor in the earphone to shield the capacitance sensor from external influences and to achieve an accurate identification of the wearing state of the earphone.

### SUMMARY

Embodiments of the present disclosure provide an earphone including two speaker assemblies and a connection member. The connection member is configured to connect the two speaker assemblies. The connection member provides a clamping force for placing the two speaker assemblies at a user's head through a bending deformation. The connection member includes a housing with an accommodation cavity, a capacitance sensor is disposed in the accommodation cavity, and the capacitance sensor is configured to identify a bending state of the connection member. The capacitance sensor includes a shielding structure that has a constant potential and is used to reduce an effect of an external electric field on the capacitance sensor.

In some embodiments, the connection member includes two ear hook assemblies and a rear hanging assembly, the two speaker assemblies are connected to the rear hanging assembly through the two ear hook assemblies, respectively, and the capacitance sensor is disposed in the accommodation cavity formed by the rear hanging assembly.

In some embodiments, the capacitance sensor further includes a first electrode plate, the shielding structure is taken as a second electrode plate of the capacitance sensor to form a capacitor with the first electrode plate, the second electrode plate has a cavity, and the first electrode plate is disposed within the cavity.

In some embodiments, the first electrode plate and the second electrode plate are flexible conductors, and a space between the first electrode plate and the second electrode plate is filled with a flexible substrate.

In some embodiments, the first electrode plate includes a plurality of electrode sub-plates spaced apart from each other.

In some embodiments, the plurality of electrode sub-plates are electrically connected to each other through first wires.

In some embodiments, the capacitance sensor further includes a first electrode plate and a second electrode plate, the shielding structure is a conductor with a cavity, and the first electrode plate and the second electrode plate are disposed within the cavity.

In some embodiments, the conductor includes any one of a conductive adhesive, a flexible conductive cloth, and a conductive film.

In some embodiments, the rear hanging assembly further includes a skeleton structure, the capacitance sensor is fitted to the skeleton structure.

In some embodiments, the cavity does not have an opening.

In some embodiments, the skeleton structure is a conductor skeleton, the cavity has the opening, and the opening faces the conductor skeleton.

In some embodiments, the earphone further includes a wiring, the wiring is disposed in the accommodation cavity of the rear hanging assembly.

In some embodiments, the earphone further includes a platform structure disposed on the rear hanging assembly, and the capacitance sensor is fixed to the platform structure.

In some embodiments, the platform structure is a solid conductor.

In some embodiments, the capacitance sensor is a differential capacitance sensor.

Additional features are set forth in part in the following description and are apparent to those skilled in the art by reference to the following and the accompanying drawings, or are appreciated by the generation or operation of examples. Features of the present disclosure are realized and obtained by practicing or using aspects of the methods, tools, and combinations set forth in the following detailed examples.

### BRIEF DESCRIPTION OF THE DRAWINGS

The present disclosure will be further illustrated by way of exemplary embodiments, which are described in detail by means of the accompanying drawings. These embodiments are not limiting, and in these embodiments, the same numbering indicates the same structure, wherein

FIG. 1A is a schematic diagram illustrating a structure of an exemplary earphone according to some embodiments of the present disclosure;

FIG. 1B is a schematic diagram illustrating a structure of an exemplary earphone according to some embodiments of the present disclosure;

FIG. 2 is a schematic diagram illustrating a circuit module of an exemplary earphone according to some embodiments of the present disclosure;

FIG. 3 is a schematic diagram illustrating a structure of an exemplary capacitance sensor according to some embodiments of the present disclosure;

FIG. 4 is a schematic diagram illustrating a structure of an exemplary capacitance sensor according to some other embodiments of the present disclosure;

FIG. 5 is a schematic diagram illustrating a structure of an exemplary capacitance sensor according to some other embodiments of the present disclosure;

FIG. 6 is a schematic diagram illustrating a structure of an exemplary capacitance sensor according to yet other embodiments of the present disclosure;

FIG. 7 is a schematic diagram illustrating a cross-sectional structure of a connection member of an exemplary earphone according to some embodiments of the present disclosure;

FIG. 8 is a schematic diagram illustrating a cross-sectional structure of a connection member of an exemplary earphone according to another embodiment of the present disclosure;

FIG. 9A is a schematic diagram illustrating a cross-sectional structure of a connection member of an exemplary earphone according to other embodiments of the present disclosure;

FIG. 9B is a schematic diagram illustrating a cross-sectional structure of a connection member of an exemplary earphone according to other embodiments of the present disclosure;

FIG. 10 is a schematic diagram illustrating a platform structure of a connection member of an exemplary earphone according to some embodiments of the present disclosure;

FIG. 11 is a schematic diagram illustrating a cross-sectional structure of a connection member of an exemplary earphone according to another embodiment of the present disclosure;

FIG. 12 is a schematic diagram illustrating a circuit module of an exemplary earphone according to some other embodiments of the present disclosure;

FIG. 13A is a schematic diagram illustrating an exemplary earphone in a free placement state according to some embodiments of the present disclosure;

FIG. 13B is a schematic diagram illustrating an exemplary earphone in a normal wearing state according to some embodiments of the present disclosure;

FIG. 13C is a schematic diagram illustrating an exemplary earphone in an abnormal wearing state according to some embodiments of the present disclosure;

FIG. 14A is a schematic diagram illustrating an exemplary earphone in a free placement state according to some embodiments of the present disclosure;

FIG. 14B is a schematic diagram illustrating an exemplary earphone in a normal wearing state according to some embodiments of the present disclosure; and

FIG. 14C is a schematic diagram illustrating an exemplary earphone in an abnormal wearing state according to some embodiments of the present disclosure.

### DETAILED DESCRIPTION

To more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for those skilled in the art to apply the present disclosure to other similar scenarios based on the accompanying drawings without creative labor. It should be understood that these exemplary embodiments are given only to enable those skilled in the art to better understand and thus realize the present disclosure, and are not intended to limit the scope of the present disclosure in any way. Unless obviously obtained from the context or the context illustrates otherwise, the same numeral in the drawings refers to the same structure or operation.

As shown in the present disclosure and the claims, unless the context clearly suggests an exception, the words “one,” “an,” “a,” “a kind,” and/or “the” do not refer specifically to the singular, but also includes the plural. In general, the terms “comprise,” “comprises,” and/or “comprising,” “include,” “includes,” and/or “including,” merely prompt to include operations and elements that have been clearly identified, and these operations and elements do not constitute an exclusive listing. The methods or devices also include other operations or elements. The term “based on” is “based at least in part on.” The term “one embodiment” means “at least one embodiment”; the term “another embodiment” means “at least one other embodiment”.

In the description of the present disclosure, it is to be understood that the terms “front,” “rear,” “ear hook,” “rear hanging,” etc. indicate orientation or positional relationships based on the orientation or positional relationships shown in the accompanying drawings, which are used only for the purpose of facilitating the description of the present disclosure and simplifying the description, and are not intended to indicate or imply that the device or element referred to must have a particular orientation, or being constructed and operated in a particular orientation, or being operated in a particular manner, and therefore are not to be construed as a limitation of the present disclosure.

Additionally, the terms “first” and “second” are used only for descriptive purposes and are not to be construed as indicating or implying relative importance or implicitly specifying the count of technical features indicated. Thus, a feature defined as “first,” or “second” expressly or implicitly includes at least one of the features. In the description of the present disclosure, “plurality” means at least two, e.g., two, three, etc., unless explicitly and specifically limited otherwise.

In the present disclosure, unless otherwise expressly specified or limited, the terms “mounted,” “connected,” “connection,” “fixing,” etc. are to be understood in a broad sense, for example, as a fixed connection, a removable connection, or a one-piece connection, a mechanical connection, an electrical connection, a direct connection, an indirect connection through an intermediate medium, a connection within two components, or a connection between two components, or a connection between two components. To those skilled in the art, the specific meanings of the foregoing terms in the present disclosure are understood on a case-by-case basis.

Embodiments of the present disclosure provide an earphone (which is also referred to as an acoustic output device) including two speaker assemblies and a connection member. The connection member is configured to connect the two speaker assemblies. The connection member provides a clamping force for placing the two speaker assemblies at a user's head through a bending deformation. The connection member includes a housing with an accommodation cavity, and a capacitance sensor is disposed in the accommodation cavity. The capacitance sensor is configured to identify a bending state of the connection member. The capacitance sensor includes a shielding structure with a potential that is always constant and is used to reduce an effect of an external electric field on the capacitance sensor. Through the capacitance sensor with the shielded structure, the bending state of the connection member between the speaker assemblies is accurately detected, so as to analyze a current placement state of the earphone (e.g., a normal wearing state, an abnormal wearing state, or a free placement state), and thus further adjust an operating state of one or more electronic components (e.g., a Bluetooth module, a battery, etc.) of the earphone according to the current placement state of the earphone. In some embodiments, a plurality of sensors (e.g., the same or different types of sensors) collaborate to detect the current placement state of the acoustic output device (e.g., the earphone, smart glasses, etc.), thereby improving the accuracy of wearing detection of the acoustic output device.

The earphone provided by the embodiments of the present disclosure is described in detail below in connection with the accompanying drawings.

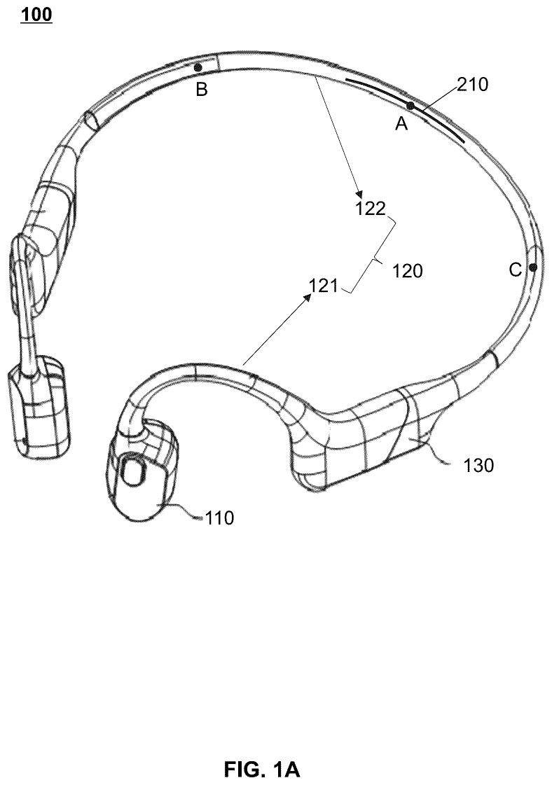

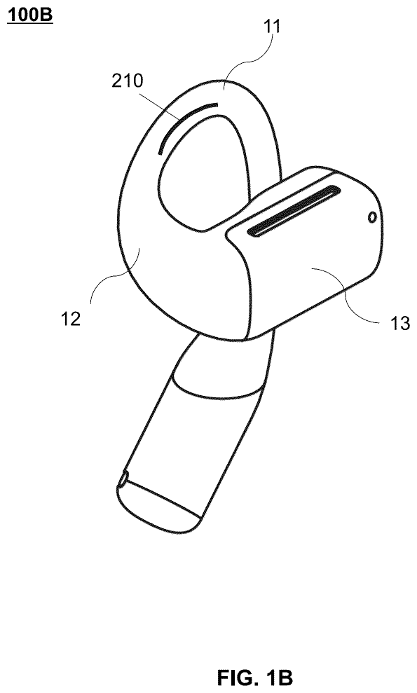

FIG. 1A is a schematic diagram illustrating a structure of an exemplary earphone according to some embodiments of the present disclosure.

In some embodiments, an earphone 100 is a bone conduction earphone, an air conduction earphone, or a bone-air conduction earphone. In some embodiments, the earphone 100 is an open earphone. In some embodiments, the earphone 100 includes a headphone, a rear hanging earphone, a single ear hanging earphone, etc. In some embodiments of the present disclosure, the bone conduction earphone with two speaker assemblies is described as an example, which does not limit the scope of the present disclosure. Referring to FIG. 1A, the earphone 100 includes two speaker assemblies 110, a connection member 120, and a capacitance sensor 210.

The two speaker assemblies 110 are configured to convert audio signals (i.e., electrical signals) into mechanical vibration signals (i.e., acoustic signals), thereby outputting a sound to a user. In some embodiments, the speaker assemblies 110 include various types, e.g., an electromagnetic type (e.g., a moving coil type, a moving iron type, etc.), a piezoelectric type, an inverse piezoelectric type, an electrostatic type, etc., which are not limited in the present disclosure.

The connection member 120 is configured to connect two speaker assemblies 110. The connection member 120 is taken as a fixing device to make the earphone 100 to be fixed relative to the user. Specifically, the connection member 120 has a certain ability to deform and recover from deformation, which provides a clamping force that fixes the two speaker assemblies 110 to a user's head or neck by the bending deformation. In some embodiments, the connection member 120 includes a head mounted connection member or a rear hanging connection member. Exemplarily, when the connection member 120 is the head mounted connection member, the user places the connection member 120 on a top of the head, thereby making the earphone 100 to be fixed relative to the user. Exemplarily, when the connection member 120 is a rear hanging connection member, the user places the connection member 120 behind the user's head or the user's neck, thereby causing the earphone 100 to be fixed relative to the user. For example, when the user wears the earphone 100 normally, the connection member 120 is fixed behind the user's head, and when the user is not using the earphone 100, the user hangs the earphone 100 around the neck, at which time the connection member 120 is fixed behind the user's neck (i.e., the earphone 100 is in an abnormal wearing state). In some embodiments, the connection between the connection member 120 and the two speaker assemblies 110 includes an injection molding connection, welding, riveting, bolting, bonding, snap-fitting, etc., or any combination thereof. In some embodiments, the connection member 120 includes a housing with an accommodation cavity. The accommodation cavity is configured to accommodate one or more components of the earphone 100, for example, communication cables for transmitting signals to the two speaker assemblies 110, a capacitance sensor 210, etc.

Referring to FIG. 1A, in some embodiments, the connection member 120 includes two ear hook assemblies 121 and a rear hanging assembly 122. The ear hook assemblies 121 cooperate with user's auricles to allow the earphone 100 to hang on the user's ears. The rear hanging assembly 122 is placed behind the user's neck or head (e.g., the rear hanging assembly 122 is placed behind the user's head when the user is normally wearing the earphone 100, and when the user is not using the earphone 100, the user hangs the earphone 100 around the neck, at which point the rear hanging assembly 122 is placed behind the user's neck). The ear hook assemblies 121 and the rear hanging assembly 122 cooperate to provide the clamping force for placing the two speaker assemblies 110 to the user's head or ear, so that the earphone 100 hangs stably on the user's ear and is unlikely to fall off. The two speaker assemblies 110 are connected to the rear hanging assembly 122 through the two ear hook assemblies 121, respectively. In some embodiments, the capacitance sensor 210 is disposed within the accommodation cavity formed by the rear hanging assembly 122. It is appreciated that when the earphone 100 is the headphone, the connection member 120 directly connects the two speaker assemblies 110 and provides the clamping force that places the two speaker assemblies 110 to the user's head. At this point, the connection member 120 does not include the ear hook assemblies 121.

As the user makes a curvature of the connection member 120 (e.g., the rear hanging assembly 122) change in a process of wearing the earphone, in some embodiments, to accurately detect the bending state of the connection member 120 so as to accurately determine a current placement state of the earphone 100 (e.g., a normal wearing state or an abnormal wearing state). The capacitance sensor 210 is disposed at a portion of the connection member 120 (e.g., the rear hanging assembly 122) with a relatively greater curvature change, e.g., a position where a symmetry plane of the rear hanging assembly 122 intersects with the rear hanging assembly 122, i.e., a middle portion of the rear hanging assembly 122. It should be noted that in the embodiments of the present disclosure, the symmetry plane of the rear hanging assembly 122 refers to the symmetry plane formed by using two ends of the rear hanging assembly 122 as symmetry points.

In some embodiments, to further ensure that the bending state of the connection member 120 is accurately detected and thereby accurately determining the current placement state (e.g., the normal wearing state or the abnormal wearing state) of the earphone 100, the capacitance sensor 210 is also made to be sensitive in a direction consistent with a direction of the bending deformation of the connection member 120 (e.g., the rear hanging assembly 122) in the wearing process. The direction of the bending deformation of the connection member 120 (e.g., the rear hanging assembly 122) refers to a direction in which a corresponding curvature radius of the connection member 120 (or the rear hanging assembly 122) changes the most in the wearing process. It is understood that by making a sensitivity direction of the capacitance sensor 210 the same as the bending direction of the connection member 120 or the rear hanging assembly 122, the capacitance sensor 210 has an optimal response effect on a change of the bending state of the connection member 120 or the rear hanging assembly 122, thereby improving a detection accuracy of the placement state of the earphone 100.

In some embodiments, referring to FIG. 1A, at least one of the two ear hook assemblies 121 also includes an earphone compartment 130. In some embodiments, the earphone compartment 130 is configured to organize or accommodate one or more components of the earphone 100 (e.g., a processing circuit, a control circuit, a Bluetooth module, a battery, etc.).

The capacitance sensor 210 is configured to identify a bending state of the connection member 120. The bending state of the connection member 120 causes a change in a capacitance value of a capacitance structure in the capacitance sensor 210. The capacitance value (which is also referred to as a bending signal of the capacitance sensor 210) can reflect the bending degree of the connection member 120, which in turn reflects a current using state of the earphone 100. In some embodiments, a length of an electrode plate of the capacitance sensor 210 is in a range of 0.1 cm-2 cm, for example, the length is 0.5 cm, 0.8 cm, 1 cm, etc. In some embodiments, the capacitance sensor 210 includes a shielding structure (not shown in FIG. 1A). A potential of the shielding structure is constant, thereby reducing an effect of an external electric field on the capacitance sensor 210.

In some embodiments, the capacitance sensor 210 is a differential capacitance sensor. Through performing a differential calculation based on the differential capacitance sensor, a temperature drift and other common-mode signals are removed, thereby further improving the accuracy and reliability of a detection result of the capacitance sensor 210. In addition, by using the differential capacitance sensor to remove the temperature drift, there is no need to use a temperature sensor for calibration, thereby reducing the hardware cost of the earphone 100 to a certain extent. More descriptions of the shielding structure may be found elsewhere in the present disclosure, e.g., FIGS. 3-11 and the related descriptions, which are not repeated here.

In some embodiments, the capacitance sensor 210 is disposed at a middle portion of the accommodation cavity of the connection member 120 (i.e., the capacitance sensor 210 is at the same or approximately the same distance from the two speaker assemblies 110), e.g., at a position A shown in FIG. 1A. In some embodiments, the capacitance sensor 210 is also disposed proximate to one of the two speaker assemblies 110, for example, a position B or a position C shown in FIG. 1A. It should be noted that in the present disclosure, the position A, the position B, and the position C are only exemplary illustrations, which do not make limitations on specific positions.

FIG. 1B is a schematic diagram illustrating a structure of an exemplary earphone according to some embodiments of the present disclosure. In some embodiments, the earphone 100 is a single ear hanging earphone as shown in FIG. 1B. Exemplarily, as shown in FIG. 1B, an earphone 100B includes a hook-shaped portion 11, a connection portion 12, and a holding portion 13. The connection portion 12 connects the hook-shaped portion 11 to the holding portion 13 so that the earphone 100B is curved in a three-dimensional (3D) space when the earphone 100B is in a non-wearing state (i.e., a free placement state). In other words, in the 3D space, the hook-shaped portion 11, the connection portion 12, and the holding portion 13 are not coplanar. In this manner, when the earphone 100B is in a normal wearing state, the hook-shaped portion 11 is used primarily for hooking between a back side of an ear of the user and the user's head, and the holding portion 13 is used primarily for contacting a front side of the ear of the user, thereby allowing the holding portion 13 and the hook-shaped portion 11 to cooperate to clamp the ear. Exemplarily, the connection portion 12 extends from the head toward an outer side of the head, thereby cooperating with the hook-shaped portion 11 to provide a clamping force for the holding portion 13 against the front side of the ear.

Due to the fact that the bending degree of the connection portion 12 and/or the hook-shaped portion 11 (e.g., a region near the position where the connection portion 12 is connected to the hook-shaped portion 11) may change when the user wears the earphone 100B, the capacitance sensor 210 is disposed at a portion where the bending degree of the connection portion 12 and/or the hook-shaped portion 11 changes relatively great, so as to detect the current placement state of the earphone 100B (e.g., the normal wearing state or the non-wearing state). Further, the capacitance sensor 210 includes a shielding structure (not shown in FIG. 1B) that has a constant potential and is used to reduce an effect of an external electric field on the capacitance sensor 210.

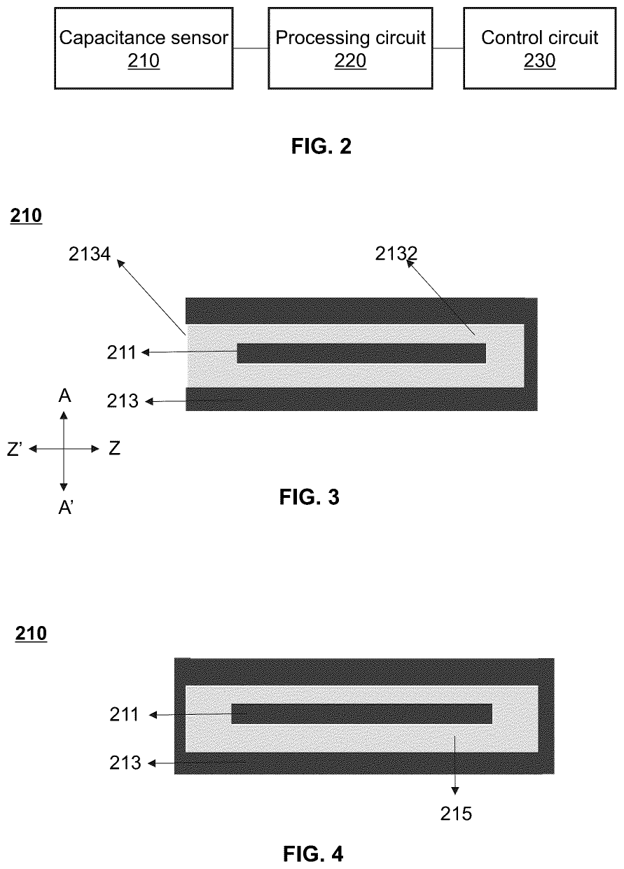

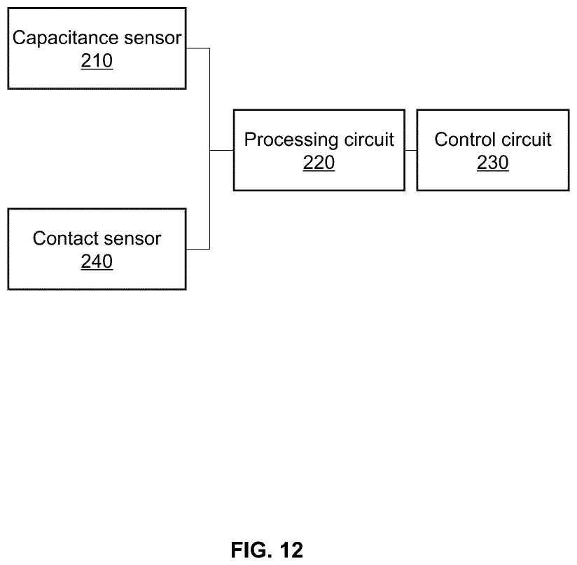

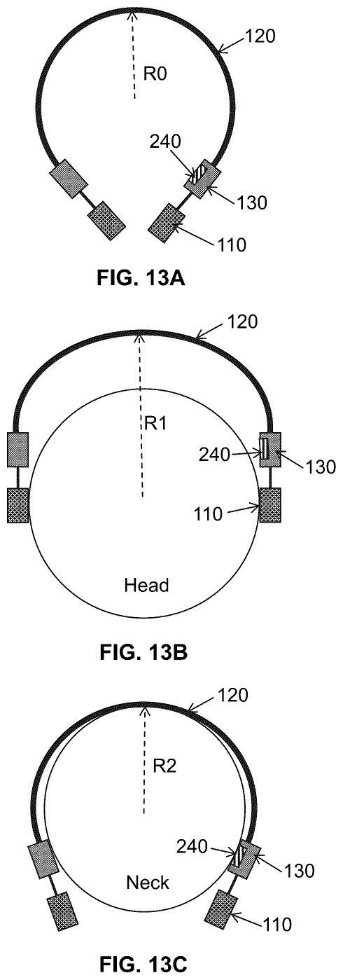

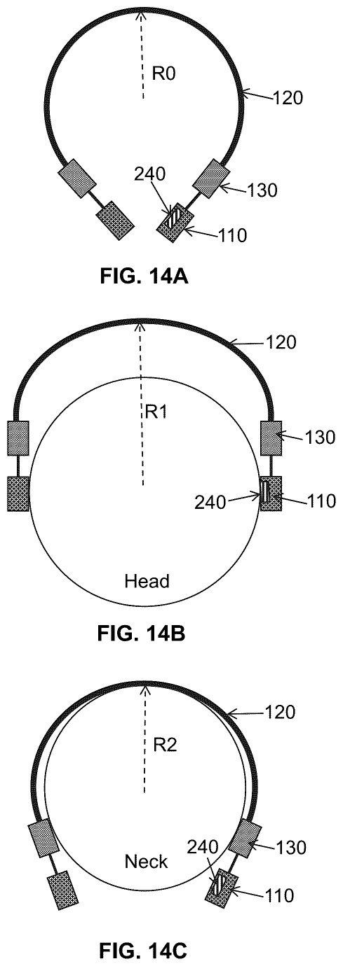

FIG. 2 is a schematic diagram illustrating a circuit module of an exemplary earphone according to some embodiments of the present disclosure. Referring to FIG. 2, in some embodiments, the earphone 100 also includes a processing circuit 220 and a control circuit 230. The processing circuit 220 is electrically connected to the capacitance sensor 210 and the control circuit 230. The processing circuit 220 determines a bending state of the connection member 120 based on a bending signal detected by the capacitance sensor 210. Specifically, the processing circuit 220 determines an equivalent curvature radius of the connection member 120 based on the bending signal detected by the capacitance sensor 210, thereby determining the bending state (or a bending degree) of the connection member 120. Exemplarily, in some embodiments, a mapping relationship between the bending signal and the equivalent curvature radius of the connection member 120 is preconfigured based on experimental data. The processing circuit 220 determines the equivalent curvature radius of the connection member 120 based on the bending signal detected by the capacitance sensor 210 and the mapping relationship, thereby determining the bending state (or the bending degree) of the connection member 120. It is appreciated that in the embodiments of the present disclosure, when the earphone 100 is a bone conduction earphone as shown in FIG. 1A, due to a limitation of a shape of the rear hanging assembly 122 (e.g., the shape of a titanium wire), the measurement of the equivalent curvature radius is easier to achieve than the measurement of a stress alone, and a result of the measurement is more reliable. In addition, a more stable mapping relationship is established between the equivalent curvature radius and the placement state of the bone conduction earphone, which is less susceptible to an interference of factors such as pressure and shaking, and thus allows for a more accurate wearing detection. Further, the processing circuit 220 determines the placement state of the earphone 100 based on the bending state of the connection member 120. In some embodiments, the placement state of the earphone 100 includes one of a normal wearing state, an abnormal wearing state, or a free placement state. The normal wearing state refers to a state of the earphone 100 when the earphone 100 is normally worn by a user for playing audio; the free placement state refers to a state of the earphone 100 when it is not worn by the user; the abnormal wearing state refers to a state of the earphone 100 other than the normal wearing state and the free placement state, for example, a state when the user hangs the earphone 100 around a neck. More descriptions of the determination of the placement state of the earphone 100 may be found elsewhere in the present disclosure, for example, in FIG. 12, FIGS. 13A-13C, FIGS. 14A-14C, and descriptions thereof, which are not repeated here.

The control circuit 230 adjusts an operating state of one or more electronic assemblies (e.g., a Bluetooth module, a battery, etc.) of the earphone 100 based on a determination result of the processing circuit 220. Specifically, when the earphone 100 is in the normal wearing state, the control circuit 230 controls at least one of the one or more electronic assemblies to be in an awake state, and when the earphone 100 is in the abnormal wearing state or in the free placement state, the control circuit 230 controls the at least one of the one or more electronic assemblies to be in a low power operating state or a disabled state. For example, when it is determined that the earphone 100 is in the normal wearing state, the control circuit 230 controls the earphone 100 to enter the awake state (i.e., connecting the battery to the circuit); conversely, when it is determined that the earphone 100 is in the abnormal wearing state or the free placement state, the control circuit 230 controls the earphone 100 to be in a standby state (i.e., disconnecting the battery from the circuit). For example, when it is determined that the earphone 100 is in the normal wearing state, the control circuit 230 controls the Bluetooth module to turn on a Bluetooth function, and conversely, when it is determined that the earphone 100 is in the abnormal wearing state or the free placement state, the control circuit 230 controls the Bluetooth module to disable the Bluetooth function. A further example, when it is determined that the earphone 100 is in the normal wearing state, the control circuit 230 controls the earphone 100 to automatically play music, and conversely, when it is determined that the earphone 100 is in the abnormal wearing state or the free placement state, the control circuit 230 controls the earphone 100 to stop playing the music.

In some embodiments, the processing circuit 220 also determines a head circumference of the user based on the bending signal detected by the capacitance sensor 210, thereby determining a force between the speaker assembly 110 and the user's head or ear. Further, the processing circuit 220 optimizes an acoustic output algorithm of the two speaker assemblies 110 based on the force between the speaker assembly 110 and the user's head or ear, thereby adjusting the acoustic output signals, and enabling the user to obtain the best sound effect and wearing experience. For example, the equivalent curvature radius of each connection member 120 corresponds to one head circumference. The processing circuit 220 determines the head circumference of the user based on the determined equivalent curvature radius of the connection member 120. A size of the head circumference reflects a magnitude of the force between the speaker assembly 110 and the user's head or ear. The greater the head circumference, the greater the force between the speaker assembly 110 and the user's head or ear. When the force between the speaker assembly 110 and the user's head or ear is less than a certain value, a loss of low-frequency signals in the audio signal transmitted by the speaker assembly 110 to the skin is greater. At this time, the acoustic output algorithm of the speaker assembly 110 is balanced by increasing an output gain of low-medium frequency signals, so as to avoid a problem of the reduction of the low-medium frequency signals in the output signal of the speaker assembly 110 due to a wearing situation, and to improve the user experience.

It should be noted that in some embodiments of the present disclosure, the earphone 100 obtains the audio signal by means of wired communication and/or wireless communication. For example, in some embodiments, the earphone 100 also includes a cable as well as a connector. The connector is used to connect other devices (e.g., cell phones, computers, etc.) to obtain audio data. The audio data is transmitted via the cable to the two speaker assemblies 110 for output, thereby converting an electrical signal to an acoustic signal. For another example, in some embodiments, the earphone 100 includes a wireless communication module (not shown in FIG. 1A). The earphone 100 receives the audio data from other devices via the wireless communication module and outputs sound through the two speaker assemblies 110. Exemplary wireless communication modules include a Bluetooth module, an infrared communication module, a WiFi module, a ZigBee module, etc.

FIG. 3 is a schematic diagram illustrating a structure of an exemplary capacitance sensor according to some embodiments of the present disclosure. FIG. 4 is a schematic diagram illustrating a structure of an exemplary capacitance sensor according to some other embodiments of the present disclosure.

Referring to FIG. 3, in some embodiments, the capacitance sensor 210 includes a first electrode plate 211 and a shielding structure 213. The shielding structure 213 is taken as a second electrode plate of the capacitance sensor 210 to form a capacitor with the first electrode plate 211. For example, the first electrode plate 211 and at least a portion of the second electrode plate formed by the shielding structure 213 are parallel to each other to form the capacitor. Specifically, an area of the first electrode plate 211 is smaller than an area of the second electrode plate formed by the shielding structure 213, as shown in FIG. 3. The second electrode plate formed by the shielding structure 213 has a cavity 2132, and the first electrode plate 211 is disposed within the cavity 2132.

In some embodiments, the shielding structure 213 (e.g., the second electrode plate) has a closed structure or a non-closed structure. The closed structure is understood as that the cavity 2132 formed by the shielding structure 213 does not have an opening. It is appreciated that the shielding structure 213 having the closed structure refers to that the shielding structure 213 is surrounded by conductors except for a small gap caused by necessary signal wires. The non-closed structure is understood as that the cavity 2132 formed by the shielding structure 213 has an opening. In some embodiments, the opening faces a direction perpendicular to a direction (i.e., direction AA′ in FIG. 3) of the two electrode plates facing each other (e.g., the opening faces a direction ZZ′ as shown in FIG. 3). For example, as shown in FIG. 3, the cavity 2132 of the second electrode plate formed by the shielding structure 213 has an opening 2134, and the opening 2134 is located at one end of the first electrode plate 211. For another example, the second electrode plate formed by the shielding structure 213 completely or substantially completely wraps around the first electrode plate 211, as shown in FIG. 4. That is, the cavity 2132 of the second electrode plate constituted by the shielding structure 213 does not have the opening. In some embodiments, a size of the opening 2134 affects the shielding effect of the non-enclosed shielding structure 213, and therefore, the size of the opening 2134 is designed according to actual needs, and the present disclosure does not make specific limitations thereon.

Further, by setting a potential (or an electric potential) of the shielding structure 213 (i.e., the second electrode plate) to a fixed value (i.e., the potential is constant), electric field lines of the capacitance sensor 210 are made to leak as little as possible in the air, thereby reducing an effect of an external electric field on the capacitance sensor 210 and improving detection accuracy of the capacitance sensor 210. In some embodiments, to ensure that the potential of the shielding structure 213 of the capacitance sensor 210 is the fixed value, the shielding structure 213 is connected to a reference potential end. It is appreciated that in some embodiments, the reference potential refers to an end of the earphone 100 that has a constant potential, which is equal to or unequal to 0. When the potential of the reference potential end is 0, the reference potential end is a ground end (GND). In some embodiments, when the shielding structure 213 is connected to the GND, it can create the same potential difference between the shielding structure 213 (i.e., the second electrode plate) and the first electrode plate 211, and, as the electric field lines of the shielding structure 213 are perpendicular to the surface thereof, it is ensured that the electric field lines between the second electrode plate formed by the shielding structure 213 and the first electrode plate 211 do not change, and the capacitance sensor 210 is not subject to external influences. In some embodiments, an impedance between the shielding structure 213 and the reference potential in the processing circuit 220 is limited by external influences, such that the potential of the shielding structure 213 of the capacitance sensor 210 is a fixed value. Exemplarily, an excitation signal with the same potential as the potential of the first electrode plate 211 is applied to the shielding structure 213 (i.e., the second electrode plate) by active excitation, such that the potential difference between the shielding structure 213 and the first electrode plate 211 is zero. It is understood that when the shielding structure 213 (i.e., the second electrode plate) and the first electrode plate 211 are isoelectric, no electric field line is distributed between the shielding structure 213 and the first electrode plate 211, and at this time, the impedance between the shielding structure 213 and the reference potential in the processing circuit 220 is not affected by the external world.

In some embodiments, to adapt to the detection of the bending state of the earphone 100, the first electrode plate 211 and the second electrode plate formed by the shielding structure 213 are flexible conductors. The flexible conductor is an object that has a certain degree of flexibility and is electrically conductive. In some embodiments, the flexible conductor includes a fluid conductor or a non-fluid conductor. In some embodiments, the fluid conductor includes a liquid metal, or a conductive solution with fluidity formed based on conductor particles (e.g., metal particles, carbon nanotubes, etc.) and fluid solvent. In some embodiments, the non-fluid conductor includes a non-fluid conductive coating formed based on conductive particles and a cured non-fluid flexible solution. Exemplary conductor particles include carbon black, carbon nanotubes, graphene, silver powder, copper powder, etc. Exemplary cured non-fluid flexible solution includes epoxy resin, polyvinyl chloride (PVC), polyimide resin, phenolic resin, etc.

In some embodiments, to ensure absolute insulation between the two electrode plates of the capacitance sensor 210 during the deformation of the capacitance sensor 210, a surface of the first electrode plate 211 and/or a surface of the second electrode plate formed by the shielding structure 213 are wrapped with an insulating material, respectively. In some embodiments, to ensure absolute insulation between the two electrode plates of the capacitance sensor 210 during the deformation of the capacitance sensor 210, a space between the first electrode plate 211 and the second electrode plate formed by the shielding structure 213 is filled with a flexible substrate 215. The flexible substrate 215 is made of an insulating material for dividing the first electrode plate 211 and the second electrode plate formed by the shielding structure 213 into two portions that do not contact each other. Exemplarily, in some embodiments, the flexible substrate 215 includes one or more flexible insulating materials such as a hot melt adhesive type material, silicone, silicone rubber, polydimethylsiloxane (PDMS), etc.

In some embodiments, the capacitance sensor 210 also includes a wire (not shown in the figure) that is connected to the first electrode plate 211 and the second electrode plate formed by the shielding structure 213, respectively, so as to lead signals from the first electrode plate 211 and the second electrode plate formed by the shielding structure 213. In some embodiments, the wire is connected to the processing circuit 220, and the processing circuit 220 determines a current bending state of the connection member 120 based on the signal output by the wire and a mapping relationship between the signal and the bending degree of the connection member 120.

By adopting the shielding structure as the second electrode plate of the capacitance sensor, electromagnetic shielding is realized, and interference of the external electric field to the capacitance sensor is reduced while effectively reducing the processing difficulty of the shielding structure of the capacitance sensor, and to a certain extent reducing an overall thickness and cost of the capacitance sensor and the shielding structure, which is conducive to industrial production.

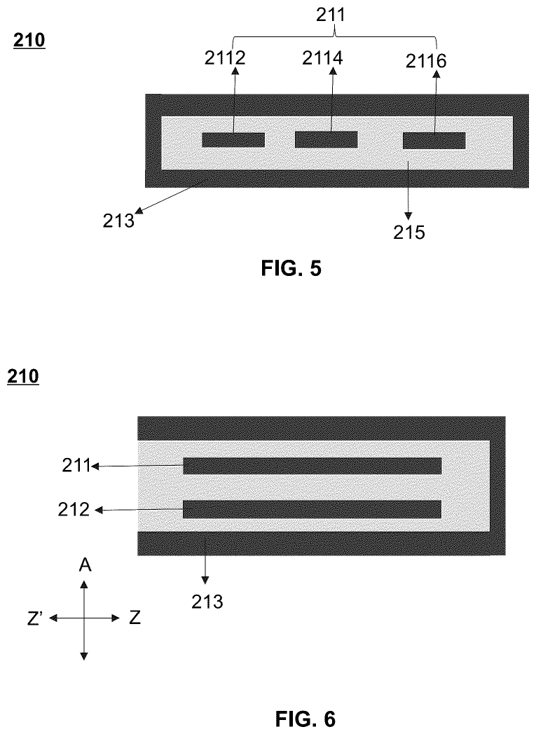

FIG. 5 is a schematic diagram illustrating a structure of an exemplary capacitance sensor according to some other embodiments of the present disclosure.

In some embodiments, referring to FIG. 5, the first electrode plate 211 includes a plurality of electrode sub-plates spaced apart from each other, e.g., electrode sub-plates 2112, 2114, and 2116. In some embodiments, the plurality of electrode sub-plates are independent from each other (e.g., the plurality of electrode sub-plates and the second electrode plate formed by the shielding structure 213 are all separated from each other by the flexible substrate 215), and each of the electrode plates outputs its signal through a lead (or a wire) corresponding thereto. The processing circuit 220 separately processes the signals output from the individual leads to determine a current placement state of the earphone 100. For example, the processing circuit 220 determines a current bending degree of a corresponding position of the electrode sub-plate based on the signals output from the electrode sub-plates at different positions. The processing circuit 220 determines, based on the bending degree of the each position, the current placement state of the earphone 100. For example, for a single ear hanging earphone 100B, the different electrode sub-plates are uniformly or non-uniformly distributed in the hook-shaped portion 11 and/or the connection portion 12. For each of the electrode sub-plates, the processing circuit 220 determines the bending degree at each position based on the signal output therefrom. Only when the bending degree of the electrode sub-plate at each position exceeds a threshold, the processing circuit 220 determines that the earphone 100 is in the normal wearing state. In some embodiments, the plurality of electrode sub-plates have the same or different distances from the second electrode plate formed by the shielding structure 213.

In some embodiments, the plurality of electrode sub-plates are electrically connected to each other through wires, in other words, i.e., the plurality of electrode sub-plates are connected in series with each other through the wires. After being connected in series through the wires, the plurality of electrode sub-plates output their signals through only one lead. The lead is electrically connected to any electrode sub-plate. In this way, the capacitance sensor 210 is made less likely to be broken in a process of bending and deforming with the rear hanging assembly 122 of the earphone 100, thereby increasing the service life of the capacitance sensor 210.

FIG. 6 is a schematic diagram illustrating a structure of an exemplary capacitance sensor according to yet other embodiments of the present disclosure.

Referring to FIG. 6, in some embodiments, the capacitance sensor 210 includes a first electrode plate 211, a second electrode plate 212, and a shielding structure 213. The shielding structure 213 is a conductor (e.g., a metallic conductor and/or a non-metallic conductor) with a cavity. The first electrode plate 211 and the second electrode plate 212 are disposed within the cavity of the shielding structure 213. In some embodiments, the shielding structure 213 is disposed having a closed structure or a non-closed structure, as described in FIG. 3 or FIG. 4, which is not repeated herein.

In some embodiments, a horizontal and vertical (including a ZZ′ direction and an AA′ direction) arrangement between the first electrode plate 211 and the second electrode plate 212 is symmetrical or is offset as required.

In some embodiments, to make the capacitance sensor 210 suitable for the wearing detection of the earphone 100, the conductor used to prepare the shielding structure 213 has a certain degree of elasticity, so as to be able to deform in response to the deformation of the rear hanging assembly 122 of the earphone 100. Exemplary conductor includes a conductive adhesive, a flexible conductive cloth, a conductive film (e.g., a conductive silver paste film, a conductive carbon paste film), etc.

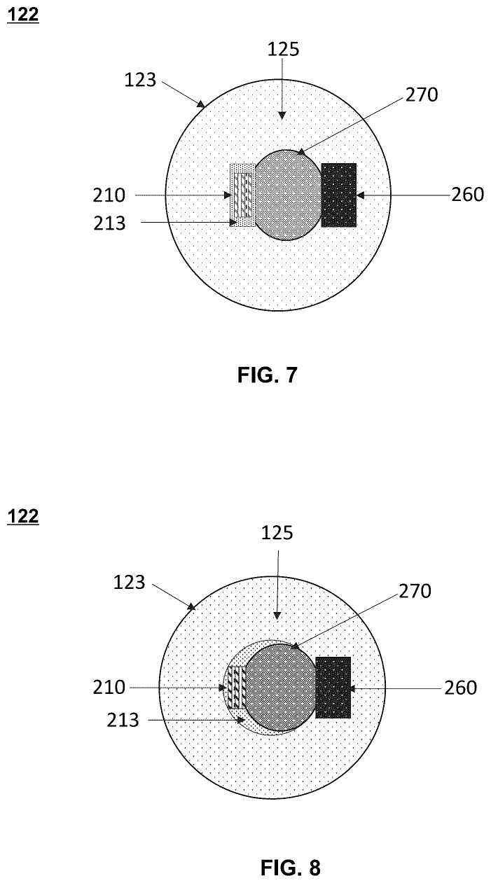

In some embodiments, in order to satisfy a supportive property and a clamping property of the connection member 120 during use, a skeleton structure (e.g., a skeleton structure 270 in FIG. 7) is disposed inside the rear hanging assembly 122. The skeleton structure has stiffness or rigidity, which provides a clamping force required by a user when wearing the skeleton structure through the ability of deformation as well the ability to recover from deformation. Exemplarily, in some embodiments, the skeleton structure includes a metallic structure such as titanium wire, titanium-nickel wire (sheet), etc.

In some embodiments, the stiffness of the skeleton structure in a bending direction of the rear hanging assembly 122 is greater than a stiffness of the capacitance sensor 210 in the bending direction of the rear hanging assembly 122, so that the skeleton structure is able to provide, through the bending deformation, a clamping force that can place the two speaker assemblies 110 on the user's head. In some embodiments, to further ensure that the capacitance sensor 210 accurately detects the change in the bending state of the connection member 120, the capacitance sensor 210 is attached to the skeleton structure. It is to be known that in some embodiments, after the capacitance sensor 210 is attached to the skeleton structure, if the skeleton structure is a conductor, such as made of a titanium wire, the skeleton structure is taken as a portion of the capacitance sensor 210 (e.g., the shielding structure 213 of the aforementioned capacitance sensor), and both of them together serve to detect the change of the bending state of the connection member 120.

FIG. 7 is a schematic diagram illustrating a cross-sectional structure of a connection member of an exemplary earphone according to some embodiments of the present disclosure. FIG. 8 is a schematic diagram illustrating a cross-sectional structure of a connection member of an exemplary earphone according to another embodiment of the present disclosure.

Referring to FIG. 7, in some embodiments, the connection member 120 includes a housing 123. The housing 123 forms the accommodation cavity 125. In some embodiments, a wiring 260, the skeleton structure 270, and the capacitance sensor 210, etc., are accommodated in the accommodation cavity 125. The wiring 260 refers to cables arranged inside the accommodation cavity 125, which are used for transmitting audio signals, bending signals detected by the capacitance sensor 210, and control signals for controlling operation states of the two speaker assemblies 110, a Bluetooth module, and other components.

In some embodiments, the housing 123 is made of a rigid material with a certain hardness or stiffness, which has a certain deformability and provides a clamping force required for a user when wearing. In some embodiments, the rigid material includes a metallic material or a non-metallic material, such as aluminum alloy, nickel-titanium alloy, plastic, etc. In some embodiments, an outer contour of the housing 123 is a regular shape such as a cylinder, an ellipsoid, a prism (e.g., quadrilateral, pentagonal, hexagonal, etc.), or other irregular shapes.

Referring to FIGS. 7 and 8, in some embodiments, the wiring 260 and the capacitance sensor 210 are respectively disposed on two sides of the skeleton structure 270. In some embodiments, to avoid the wiring 260, the skeleton structure 270, and the capacitance sensor 210 from being shaken or collided within the accommodation cavity 125 by an external force, which generates a noise or has an effect on a detection result of the capacitance sensor 210, the wiring 260 and the capacitance sensor 210 are fixed to an inner wall of the accommodation cavity 125 in manners such as bonding, snap-fitting, etc. In some embodiments, to further avoid the foregoing problems, a filler is used to fill a gap in the accommodation cavity 125, for example, the gap is filled with silica gel, sponge, etc. It should be noted that in the present disclosure, a shape of the wiring 260 is only an example. In some other embodiments, the wiring 260 has other shapes, e.g., cylindrical, elliptical, prismatic, etc.

In some embodiments, referring to FIG. 7, the capacitance sensor 210 dose not have an opening. That is, after the shielding structure 213 of the capacitance sensor 210 completely or substantially completely wraps the capacitance structure in the capacitance sensor 210, the shielding structure 213 is then attached to the skeleton structure 270. At this point, the skeleton structure 270 is a conductor skeleton (which has conductive properties) or a non-conductor skeleton (which does not have conductive properties). It is understood that, in the earphone 100 with a connection member as shown in FIG. 7, the shielding structure 213 serves as an electromagnetic shielding for the capacitance sensor 210 to minimize the effect of an external electric field on the capacitance sensor 210.

In some embodiments, referring to FIG. 8, the skeleton structure 270 is a conductor skeleton. At this point, a cavity formed by the shielding structure 213 of the capacitance sensor 210 has an opening facing the skeleton structure 270. That is, when the shielding structure 213 of the capacitance sensor 210 partially wraps the capacitance structure in the capacitance sensor 210, by attaching the skeleton structure 270 to the opening of the shielding structure 213, the opening of the shielding structure 213 is closed to shield an interference from the external electric field. It is understood that, in the earphone 100 with a connection member as shown in FIG. 8, the shielding structure 213 and the skeleton structure 270 together have an electromagnetic shielding effect for the capacitance sensor 210 to reduce the influence of the external electric field on the capacitance sensor 210.

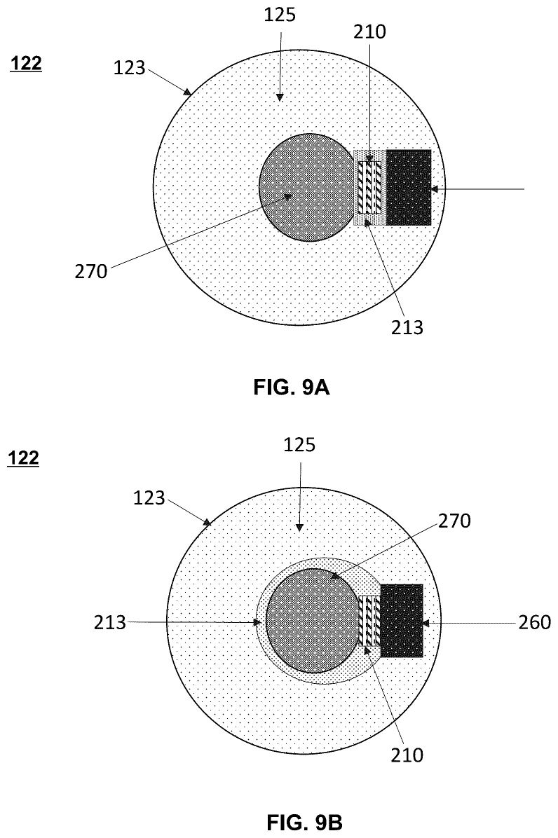

FIG. 9A and FIG. 9B are schematic diagrams illustrating a cross-sectional structure of a connection member of an exemplary earphone according to other embodiments of the present disclosure.

Referring to FIG. 9A and FIG. 9B, in some embodiments, the wiring 260 and the capacitance sensor 210 are disposed on the same side of the skeleton structure 270. The capacitance sensor 210 is disposed between the wiring 260 and the skeleton structure 270, and a portion of a region of the capacitance sensor 210 is fitted to the wiring 260 and the skeleton structure 270.

In some embodiments, as shown in FIG. 9A, the capacitance sensor 210 does not have an opening. That is, after the shielding structure 213 of the capacitance sensor 210 completely or substantially completely wraps a capacitance structure in the capacitance sensor 210, the shielding structure 213 is then fitted to the skeleton structure 270. At this point, the skeleton structure 270 is a conductor skeleton (which has conductive properties) or a non-conductor skeleton (which does not have conductive properties). It is understood that, in the earphone 100 having the connection member as shown in FIG. 9A, the shielding structure 213 acts as electromagnetic shielding for the capacitance sensor 210 to minimize the effect of an external electric field on the capacitance sensor 210.

In some embodiments, with reference to FIG. 9B, the skeleton structure 270 is a conductor skeleton. A cavity formed by the shielding structure 213 of the capacitance sensor 210 has an opening facing the skeleton structure 270. That is, when the shielding structure 213 of the capacitance sensor 210 partially wraps the capacitance structure in the capacitance sensor 210, by attaching the opening of the shielding structure 213 with the skeleton structure 270, the opening of the shielding structure 213 is closed so as to shield an interference from an external electric field. It is understood that in the earphone 100 having the connection member as shown in FIG. 9B, the shielding structure 213 and the skeleton structure 270 together act as electromagnetic shielding for the capacitance sensor 210 to minimize the external electric field influence on the capacitance sensor 210.

In some embodiments, to ensure that the capacitance sensor 210 is better connected and fixed to the skeleton structure 270 and/or the wiring 260, the shielding structure 213 is made to wrap the skeleton structure 270 and/or the wiring 260 together.

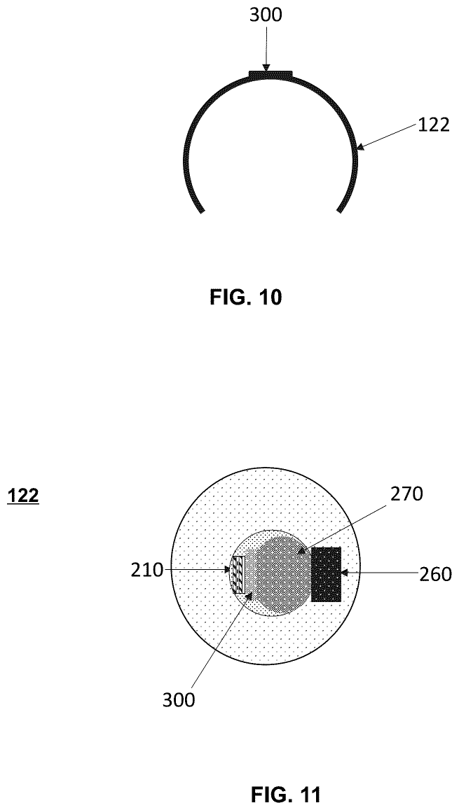

FIG. 10 is a schematic diagram illustrating a platform structure of a connection member of an exemplary earphone according to some embodiments of the present disclosure. FIG. 11 is a schematic diagram illustrating a cross-sectional structure of a connection member of an exemplary earphone according to another embodiment of the present disclosure.

In some embodiments, considering that if the capacitance sensor 210 is directly disposed in the rear hanging assembly 122, an irreversible plastic deformation of the sensor may be occured due to an excessive deformation amount of the rear hanging assembly 122 in a wearing process of a user, which in turn results in hysteresis or damage to the sensor. Accordingly, to avoid the foregoing problem while making an installation of the capacitance sensor 210 more convenient and reliable, the earphone 100 also includes a platform structure 300. It is understood that through the platform structure 300, the deformation amount at the capacitance sensor 210 is reduced to a certain extent, thereby preventing the capacitance sensor 210 from being damaged or degrading a performance thereof due to an excessive amount of deformation.

Referring to FIG. 10 or FIG. 11, the platform structure 300 is disposed in the rear hanging assembly 122 and used to install the capacitance sensor 210. Specifically, the platform structure 300 is attached to the skeleton structure 270, and the capacitance sensor 210 is attached to the platform structure.

In some embodiments, the platform structure 300 is made of a metallic or non-metallic material. When the platform structure 300 is made of the metallic material, the platform structure 300 may work together with the shielding structure 213 of the capacitance sensor 210 to provide electromagnetic shielding for the capacitance sensor 210, so as to reduce the influence of an external electric field on the capacitance sensor 210. At this time, a cavity formed by the shielding structure 213 of the capacitance sensor 210 has an opening facing the platform structure 300. That is, when the shielding structure 213 of the capacitance sensor 210 partially wraps a capacitance structure in the capacitance sensor 210, the opening of the shielding structure 213 is closed by fitting the opening of the shielding structure 213 with the platform structure 300 to shield the interference from the external electric field.

In some embodiments, the platform structure 300 is integrally molded with the skeleton structure 270 (e.g., a titanium wire). In some embodiments, the platform structure 300 is a separate component that is attached to the skeleton structure 270, e.g., by gluing.

FIG. 12 is a schematic diagram illustrating a circuit module of an exemplary earphone according to some other embodiments of the present disclosure.

In some embodiments, the earphone 100 also includes a contact sensor 240. The contact sensor 240 is disposed within a shell of the at least one speaker assembly 110 or within the earphone compartment 130 as shown in FIG. 1A. The contact sensor 240 is used to identify whether the earphone compartment 130 is close to or in contact with a user (e.g., in contact with the user's skin). In some embodiments, the earphone 100 includes left and right earphone compartments 130. To improve the accuracy of wearing detection, the contact sensor 240 is disposed in each of the left and right earphone compartments 130. Contact signals detected by the two contact sensors 240 together determine whether the earphone compartment 130 is close to or in contact with the user. For example, the processing circuit 220 determines that the earphone compartment 130 is close to or in contact with the user only when the left and right contact sensors 240 detect that the user is close to or in contact with the user. In some embodiments, the contact sensor 240 includes one or more of a capacitive proximity sensor, a pressure sensor (e.g., a thin film pressure sensor), an infrared sensor, a laser sensor, etc. It is understood that different types of contact sensors adopt different operating principles, and parameters for determining whether the corresponding component is in contact with the user are different. For example, for the pressure sensor, when a detected pressure is greater than a pressure threshold, it is determined that the corresponding component is in contact with the user, whereas when the detected pressure is less than the pressure threshold, it is determined that the corresponding component does not contact the user. For another example, for the infrared sensor, when a detected distance is greater than a distance threshold, it is determined that the corresponding component is in contact with the user; and when the detected distance is less than the distance threshold, it is determined that the corresponding component is not in contact with the user.

It is understood that when the contact sensor 240 is the capacitive proximity sensor, the capacitive proximity sensor also includes a shielding structure, which has a constant potential at all times and is used to reduce an effect of an external electric field on the capacitive proximity sensor.

The processing circuit 220 determines a current placement state of the earphone 100 based on a bending signal collected by the capacitance sensor 210 and a contact signal collected by the contact sensor 240. More content on combining the bending signals from the capacitance sensor 210 and the contact signals from the contact sensors 240 to determine the placement state of the earphone 100 may be found in FIGS. 13A-13C and FIGS. 14A-14C of the present disclosure, which is not repeated here.

In some embodiments, to reduce the power consumption produced by the earphone 100 and/or the contact sensor 240, the contact sensor 240 is in a sleep mode by default, and when the bending signal collected by the capacitance sensor 210 indicates that the connection member 120 has an equivalent curvature radius greater than or equal to a preset threshold, the processing circuit 220 controls the contact sensor 240 to collect the contact signal. In some embodiments, to reduce the power consumption produced by the earphone 100 and/or the contact sensor 240, the processing circuit 220 is made to receive the contact signal from the contact sensor 240 for processing only when the bending signal collected by the capacitance sensor 210 indicates that the equivalent curvature radius of the connection member 120 is greater than or equal to the preset threshold. The preset threshold is greater than the equivalent curvature radius of the earphone 100 when the earphone is in a free placement state.

In some embodiments, the earphone 100 does not include the connection member 120, at which point the earphone 100 is one or more of an open earphone, smart glasses, a single ear hanging earphone, a single ear in-ear earphone (e.g., a true wireless Bluetooth earphone), etc. In this situation, the earphone 100 does not include the capacitance sensor 210, but instead includes at least two other types of sensors (e.g., two types of contact sensors). The processing circuit 220 collaboratively determines whether the earphone 100 is in a normal wearing state based on signals detected by at least two other types of sensors. Merely by way of example, the earphone 100 includes a first contact sensor and a second contact sensor. The types of the first contact sensor and the second contact sensor are the same or different. For example, the first contact sensor is an infrared sensor and the second contact sensor is a thin film pressure sensor. In some embodiments, the first contact sensor and the second contact sensor are disposed at any suitable position of the earphone 100. For example, the first contact sensor and the second contact sensor are disposed in the same shell of the speaker assembly 110 or in two separate shells of the two speaker assemblies 110. For another example, for the smart glasses, the first contact sensor and the second contact sensor are disposed in one lens leg at the same time or in two lens legs respectively. For another example, for the smart glasses, the first contact sensor is disposed in a lens leg and the second contact sensor is disposed in a nosepiece. The processing circuit 220 determines whether the earphone 100 is in a normal wearing state based directly on the contact signals collected by the first contact sensor and the second contact sensor. For example, the processing circuit 220 determines that the earphone 100 is in the normal wearing state only when the first contact sensor and the second contact sensor simultaneously detect the user's proximity or contact with the user.

In some embodiments, the earphone 100 includes the contact sensor and an orientation sensor (e.g., a gyroscope). For example, corresponding to a single ear hanging earphone, the contact sensor is disposed near a top of an auricle of the ear in the normal wearing state. The processing circuit 220 determines that the earphone 100 is in the normal wearing state only when the contact sensor detects that the user is approaching or in contact with the user, and when the orientation sensor indicates that the earphone is placed vertically.

FIG. 13A is a schematic diagram illustrating an exemplary earphone in a free placement state according to some embodiments of the present disclosure. FIG. 13B is a schematic diagram illustrating an exemplary earphone in a normal wearing state according to some embodiments of the present disclosure. FIG. 13C is a schematic diagram illustrating an exemplary earphone in an abnormal wearing state according to some embodiments of the present disclosure.

In some embodiments, referring to FIGS. 13A-13C, the contact sensor 240 is disposed on an inner side of the earphone compartment 130 (i.e., a side of the earphone 100 that is close to the human skin when the earphone 100 is in the normal wearing state). When the earphone 100 is in the free placement state (as shown in FIG. 13A), an equivalent curvature radius of the connection member 120 is R0. When the earphone 100 is in the normal wearing state (as shown in FIG. 13B), due to the support of the head, the equivalent curvature radius of the connection member 120 increases to R1, i.e., R1>R0. At this time, the earphone compartment 130 is not in contact with the user's head. As shown in FIG. 13C, when the earphone 100 is in the abnormal wearing state (e.g., the user hangs the earphone 100 around the neck), due to the support of the neck, the equivalent curvature radius of the connection member 120 increases to R2, i.e., R2>R0. As a size of the neck is smaller than the size of the head, R1>R2>R0. At this time, the earphone compartment 130 is in contact with (or close to) the neck of the user. Based on this, in some embodiments, a current equivalent curvature radius of the connection member 120 as well as a contact state between the user and the contact sensor 240 are determined based on the bending signal generated by the capacitance sensor 210, which together determine the current placement state of the earphone 100.

Merely by way of example, when the bending signal detected by the capacitance sensor 210 is a first bending signal indicating that the equivalent curvature radius of the connection member 120 (or the rear hanging assembly 122) is greater than or equal to a preset threshold, an output of the capacitance sensor 210 is 1 (i.e., the output is a high level), and conversely, when the bending signal detected by the capacitance sensor 210 is a second bending signal indicating that the equivalent curvature radius of the connection member 120 is less than the preset threshold, the output of the capacitance sensor 210 is 0 (i.e., the output is a low level). Similarly, when the contact signal detected by the contact sensor 240 is a first contact signal indicating that the earphone compartment 130 is not in contact with the user (or that a distance from the user is greater than a preset distance threshold), an output of the contact sensor 240 is 1 (i.e., the output is a high level), and conversely, when the contact signal detected by the contact sensor 240 is a second contact signal indicating that the earphone compartment 130 is in contact with the user (or that the distance from the user is less than the preset distance threshold), the output of the contact sensor 240 is 0 (i.e., the output is a low level).

It should be noted that in some embodiments of the present disclosure, when the earphone 100 includes a plurality of capacitance sensors 210 disposed at different positions, a total bending signal is determined based on the bending signals detected by the plurality of capacitance sensors 210 together. For example, when the bending signals detected by the capacitance sensors 210 provided at position A, position B, and position C as shown in FIG. 1A all indicate that the equivalent curvature radius of the connection member 120 (or the rear hanging assembly 122) is greater than or equal to the preset threshold, the total bending signal output by the plurality of capacitance sensors 210 is determined to be the first bending signal (i.e., the value of which is 1). As another example, when the bending signal detected by the capacitance sensor 210 provided at position B indicates that the equivalent curvature radius of the connection member 120 (or the rear hanging assembly 122) is greater than or equal to the preset threshold, while the bending signals detected by the capacitance sensors 210 at positions A and C indicate that the equivalent curvature radius of the connection member 120 (or the rear hanging assembly 122) is equal to the equivalent curvature radius of the earphone 100 when the earphone 100 is freely placed, it indicates that the bending deformation occurred at position B is generated due to mistaken touching. At this time, the total bending signal of the plurality of capacitance sensors 210 is determined to be the second bending signal (i.e., the value of which is 0).

Further, the processing circuit 220 determines whether the earphone 100 is in the normal wearing state based on the output of the capacitance sensor 210 and the output of the contact sensor 240, thereby issuing an instruction to the control circuit 230 based on whether the earphone 100 is in the normal wearing state. The control circuit 230 controls an operating state of the earphone 100 based on the received control instruction. In some embodiments, referring to Table 1, only when the bending signal is the first bending signal (i.e., the value of which is 1) and the contact signal is the first contact signal (i.e., the value of which is 1), the output of the processing circuit 220 is 1, i.e., it indicates that the earphone 100 is determined to be in the normal wearing state. When any one of the outputs of the capacitance sensor 210 and the contact sensor 240 is 0, the output of the processing circuit 220 is 0, which indicates that the earphone 100 is determined to be in the abnormal wearing state or the free placement state. Further, the control circuit 230 controls the operating state of one or more components of the earphone 100 based on the output of the processing circuit 220. For example, when a total output of the processing circuit 220 is 1, the control circuit 230 controls the earphone 100 to enter an awake state; when the total output of the processing circuit 220 is 0, the control circuit 230 controls the earphone 100 to remain in a standby state.

TABLE 1
Scheme for detecting the placement state of the earphone when
the contact sensor is placed in the earphone compartment

| Capacitance | | |
|---|---|---|
| sensor 210 | Contact sensor | Total output |
| 1 | 1 | 1 |
| 1 | 0 | 0 |
| 0 | 1 | 0 |
| 0 | 0 | 0 |

It is noted that the output signals shown in Table 1 are only exemplary illustrations, and in some embodiments, other manners are used for expressing the bending signal detected by capacitance sensors 210, the contact signal detected by the contact sensors 240, and the total output signal of the earphone 100. For example, in some embodiments, when the contact signal detected by the contact sensor 240 is the aforementioned first contact signal, its output is expressed by 0 (i.e., the output is a low level), and conversely, when the contact signal detected by the contact sensor 240 is the aforementioned second contact signal, its output is expressed by 1 (i.e., the output is a high level).

FIG. 14A is a schematic diagram illustrating an exemplary earphone in a free placement state according to some embodiments of the present disclosure. FIG. 14B is a schematic diagram illustrating an exemplary earphone in a normal wearing state according to some embodiments of the present disclosure. FIG. 14C is a schematic diagram illustrating an exemplary earphone in an abnormal wearing state according to some embodiments of the present disclosure.

In some embodiments, referring to FIGS. 14A-14C, the contact sensor 240 is disposed inside a shell of the at least one speaker assembly 110 (e.g., a side of the earphone 100 that is close to a human skin when the earphone 100 is in the normal wearing state) for identifying whether the speaker assembly 110 is in contact with (or close to) the user. Unlike FIGS. 13A-13C, an output of the contact sensor 240 is 1 (i.e., the output is a high level) when the contact signal detected by the contact sensor 240 is a first contact signal indicating that the speaker assembly 110 is not in contact with the user (or a distance from the user is greater than a preset distance threshold), and, conversely, the output of the contact sensor 240 is 0 (i.e., the output is a low level) when the contact signal detected by the contact sensor 240 is a second contact signal indicating that the speaker assembly 110 is in contact with the user (or the distance from the user is less than the preset distance threshold), the output of the contact sensor 240 is 0 (i.e., the output is a low level).

In some embodiments, as shown in Table 2, when the contact sensor 240 is disposed inside the shell of the speaker assembly 110, only when the bending signal detected by the capacitance sensor 210 is the aforementioned first bending signal (i.e., the value of which is 1) and the signal detected by the contact sensor 240 is the second contact signal (i.e., the value of which is 0), the output of the processing circuit 220 is 1, i.e., it is determined that the earphone 100 is in the normal wearing state. When the bending signal detected by the capacitance sensor 210 is the aforementioned second bending signal (i.e., the value of which is 0) and/or the signal detected by the contact sensor 240 is the first contact signal (i.e., the value of which is 1) indicating that the speaker assembly 110 is not in contact with the user (or a distance from the user is greater than the preset distance threshold), the output of the processing circuit 220 is 0, that is, it is determined that the earphone 100 is in the abnormal wearing state or the free placement state. Further, the control circuit 230 controls the operating state of one or more components of the earphone 100 based on the output of the processing circuit 220. For example, when the total output of the processing circuit 220 is 1, the control circuit 230 controls the earphone 100 to enter an awake-up state; when the total output of the processing circuit 220 is 0, the control circuit 230 controls the earphone 100 to remain in the standby state.

TABLE 2
Scheme for detecting the placement state of the earphone when the
contact sensor is placed inside the shell of the speaker assembly

| Capacitance | | |
|---|---|---|
| sensor 210 | Contact sensor | Total output |
| 1 | 0 | 1 |
| 1 | 1 | 0 |
| 0 | 1 | 0 |
| 0 | 0 | 0 |

Similarly, it should be noted that the output signals shown in Table 2 are also only exemplary illustrations, and in some embodiments, other manners are used to express the bending signal detected by the capacitance sensor 210, the contact signal detected by the contact sensor 240, and the total output signal of the earphone 100. For example, in some embodiments, when the contact signal detected by the contact sensor 240 is the aforementioned first contact signal, the output of the contact sensor 240 is expressed by 0 (i.e., the output is the low level), and when the contact signal detected by the contact sensor 240 is the aforementioned second contact signal, the output of the contact sensor 240 is represented by 1 (i.e., the output is the high level).

Beneficial effects brought about by the embodiments of the present disclosure include, but are not limited to: (1) in some embodiments of the present disclosure, by setting up the shielding structure outside the capacitance sensor, the effect generated by the external electric field on the capacitance sensor can be reduced, thereby improving the accuracy of the detection results of the capacitance sensor; (2) in some embodiments of the present disclosure, by adopting the shielding structure as the second electrode plate of the capacitance sensor, an electromagnetic shielding can be realized, the interference of the external electric field to the capacitance sensor can be reduced, a difficulty of the machining process of setting the shielding structure for the capacitance sensor can be effectively reduced, an overall thickness and cost of the capacitance sensor and the shielding structure can be reduced to a certain extent, thereby increasing the product yield; (3) in some embodiments of the present disclosure, by disposing the platform structure for the installation of the capacitance sensor, the installation of the capacitance sensor is more convenient and reliable, and in this way, the capacitance sensor may not be damaged, or an operating performance of the capacitance sensor may not be reduced due to an excessive deformation during the deformation of the ear hook assembly. It should be noted that the beneficial effects generated by different embodiments are different, and the beneficial effects generated in different embodiments may be any one or a combination of the foregoing, or any other beneficial effect that may be obtained.

The basic concepts have been described above, and it is apparent to those skilled in the art that the foregoing detailed disclosure serves only as an example and does not constitute a limitation of the present disclosure. While not expressly stated herein, various modifications, improvements, and amendments are made to the present disclosure by those skilled in the art. Those types of modifications, improvements, and amendments are suggested in the present disclosure, so those types of modifications, improvements, and amendments remain within the spirit and scope of the exemplary embodiments of the present disclosure.

What is claimed is:

1. An earphone comprising:
two speaker assemblies;
a connection member configured to connect the two speaker assemblies, wherein the connection member provides a clamping force for placing the two speaker assemblies at a user's head through a bending deformation, the connection member includes a housing with an accommodation cavity, a capacitance sensor is disposed in the accommodation cavity and configured to identify a bending state of the connection member, wherein
the capacitance sensor includes a shielding structure that has a constant potential and is used to reduce an effect of an external electric field on the capacitance sensor.

2. The earphone of claim 1, wherein the connection member includes two ear hook assemblies and a rear hanging assembly, the two speaker assemblies are connected to the rear hanging assembly through the two ear hook assemblies, respectively, and the capacitance sensor is disposed in the accommodation cavity formed by the rear hanging assembly.

3. The earphone of claim 2, wherein the capacitance sensor further includes a first electrode plate, the shielding structure is taken as a second electrode plate of the capacitance sensor to form a capacitor with the first electrode plate, the second electrode plate has a cavity, and the first electrode plate is disposed within the cavity.

4. The earphone of claim 3, wherein the first electrode plate and the second electrode plate are flexible conductors, and a space between the first electrode plate and the second electrode plate is filled with a flexible substrate.

5. The earphone of claim 3, wherein the first electrode plate includes a plurality of electrode sub-plates spaced apart from each other.

6. The earphone of claim 5, wherein the plurality of electrode sub-plates are electrically connected to each other through first wires, and signals of the plurality of electrode sub-plates are output through a second wire connected to any one of the plurality of electrode sub-plates.

7. The earphone of claim 5, wherein each of the plurality of electrode sub-plates is electrically connected to a second wire, and signals of the plurality of electrode sub-plates are output through corresponding second wires, respectively.

8. The earphone of claim 2, wherein the capacitance sensor further includes a first electrode plate and a second electrode plate, the shielding structure is a conductor with a cavity, and the first electrode plate and the second electrode plate are disposed within the cavity.

9. The earphone of claim 8, wherein the conductor includes any one of a conductive adhesive, a flexible conductive cloth, and a conductive film.

10. The earphone of claim 3, wherein the rear hanging assembly further includes a skeleton structure, and the capacitance sensor is fitted to the skeleton structure.

11. The earphone of claim 10, wherein the cavity is a closed structure.

12. The earphone of claim 10, wherein the skeleton structure is a conductor skeleton, and the cavity has an opening facing the conductor skeleton.

13. The earphone of claim 2, wherein the earphone further includes a platform structure disposed on the rear hanging assembly, and the capacitance sensor is fixed to the platform structure.

14. The earphone of claim 13, wherein the platform structure is a solid conductor.

15. The earphone of claim 1, wherein the capacitance sensor is a differential capacitance sensor.

16. An earphone comprising:
a hook portion configured to hang between a back side of an ear and a head of a user;
a holding portion configured to contact a front side of the ear; and
a connection portion configured to connect the hook portion and the holding portion and extend from the head to an outer side of the head to cooperate with the hook portion to provide the holding portion with a compression force against the front side of the ear, wherein the hook portion or the connection portion is provided with a capacitance sensor configured to identify a bending state of the hook portion or the connection portion, wherein
the capacitance sensor includes a shielding structure that has a constant potential and is used to reduce an effect of an external electric field on the capacitance sensor.

17. The earphone of claim 16, wherein the capacitance sensor further includes a first electrode plate, the shielding structure is taken as a second electrode plate of the capacitance sensor to form a capacitor with the first electrode plate, the second electrode plate has a cavity, and the first electrode plate is disposed within the cavity.

18. The earphone of claim 17, wherein the first electrode plate and the second electrode plate are flexible conductors, and a space between the first electrode plate and the second electrode plate is filled with a flexible substrate.

19. The earphone of claim 17, wherein the first electrode plate includes a plurality of electrode sub-plates spaced apart from each other.

20. The earphone of claim 16, wherein the capacitance sensor further includes a first electrode plate and a second electrode plate, the shielding structure is a conductor with a cavity, and the first electrode plate and the second electrode plate are disposed within the cavity.
